(19) United States
(12) Patent Application Publication
(10) Pub. No.: US 2007/0184155 A1
(43) Pub. Date: Aug. 9, 2007

(54) Antimicrobial ice compositions, methods of preparation, and methods of use

(76) Inventors: Michael S. Harvey, Modesto, CA (US); Jonathan N. Howarth, Modesto, CA (US)

Correspondence Address: Audrey A. Millemann;Weintraub Genshlea Chediak, 11th Floor, 400 Capitol Mall, Sacramento, CA, 95814, US

(21) Appl. No.: 11/348,898

(22) Filed: Feb. 6, 2006

(51) Int. Cl. A21D 4/00

(52) U.S. Cl. 426/321

(57) ABSTRACT

The invention includes antimicrobial ice compositions (also called frozen antimicrobial compositions), methods of preparing the compositions, and methods of using the compositions. The frozen composition includes a peroxycarboxylic acid and hydrogen peroxide. The compositions are used to prevent spoilage and microbial contamination of perishable foods, such as fresh fruit, fresh vegetables, meat, poultry, fish, seafood, and shellfish. The compositions may also be used in the processing of sausage or luncheon meat to prevent spoilage and contamination.

### BACKGROUND OF THE INVENTION

1. Field of the Invention

The invention relates to compositions and methods to prevent spoilage and microbial contamination of perishable foods.

2. Description of the Related Art

Bacterial spoilage of perishable food products, such as fresh fruit and vegetables, is caused by a variety of microbes, including Erwinia and Pseudomonas species. These organisms soften the plant tissues by producing a pectinase enzyme that hydrolyzes the pectin matrix that binds plant cells together. Coliform bacteria can then invade the afflicted plant tissue and cause further damage. After the initial bacterial assault, damaged produce can be attacked by slower growing molds as decay sets in.

To preserve freshness, prolong shelf life, and reduce the incidence of potentially harmful bacterial infestations, newly-harvested fruit and vegetables are typically washed and cleansed with chlorinated water to reduce the number of spoilage and pathogenic organisms present on the produce. The produce is then stored and transported under conditions of low temperature and humidity, which retard the growth of these undesirable microorganisms. Therefore, when the produce has to be transported for long distances or to warmer climates, the produce is commonly packed in crushed ice and shipped to its destination in refrigerated vehicles.

In the produce harvesting process, the produce is sorted, selected, packed into boxes, and loaded onto pallets. The pallets are then transported to an icemaking facility. There, a combination of crushed ice and water from a slush pit is injected through slits in the boxes. This is usually done with an automated injection device. The ice remains behind and covers the produce as the water drains off and runs back into the slush pit, where it is mixed with more crushed ice.

Fresh fish, seafood and shellfish are also prone to rapid deterioration by enzymes produced by flesh and intestinal bacteria. Pseudomonas species that thrive at low and intermediate temperatures are particularly problematic, causing proteolysis of the fish flesh into volatile amines that give rotting fish its distinctive odor. To preserve freshness and prevent spoilage, seafood and shellfish are typically treated with chlorinated water and then packed on crushed ice for storage and transportation. Here again, low temperatures are required to retard the actions of the spoilage bacteria.

Chemical intervention measures and low temperature processing are also routinely practiced in the meat and poultry industries in an attempt to control the growth of pathogenic or decay-causing microorganisms. Carcasses are often sprayed with various antimicrobial solutions, such as lactic acid, acetic acid, acidified sodium chlorite (chlorine dioxide), or even peroxyacetic acid, to control the outer surface populations of pathogenic bacteria that can contaminate the meat surfaces post-visceration, such as Listeria monocytogenes, Escerichia coli, Escerichia coli 0157:H7, Campylobacter jejuni and Salmonella typhinurium. The fresh sausage and luncheon meat-making industry is particularly vulnerable to any bacterial contamination of the surface of the carcass or trimmed piece because the subsequent grinding process mixes the bacteria throughout the entire matrix, spreading contamination throughout the batch. In addition, bacteria and other microorganisms multiply very quickly at ambient temperatures, and even relatively “safe” cuts or grinds of meat can become bacterially compromised if exposed to extended holding times during processing, such as might occur if, for example, there was an equipment malfunction. Thus, the prior art has attempted to control the microbial populations prior to further processing by incorporating various (exterior) carcass washing processes in an attempt to reduce the potential for pathogenic or decay-causing microorganism contamination, which has human health and financial repercussions.

In the case of making sausage, cold temperatures are essential to prevent a phenomenon known as “fat smearing.” This occurs when the meat and fat are processed when too warm such that the fat gets smeared over the lean meat during the grinding process, which gives the appearance that the sausage is mostly fat, rather than a mixture of lean meat and fat. Therefore, in making fresh pork sausage, it is important to lower the temperature of the meat and fat as quickly as possible. The warm body of a freshly slaughtered hog may be sprayed with carbon dioxide gas to accelerate the chilling process. In addition, when the meat and fat are ground together, the spices are added along with 3% w/w shaved or flaked ice to depress the temperature further to suppress fat smearing. As the ice used in the grinding process melts, it serves as the 3% added moisture content presently allowable in fresh sausage meat in the United States. Ice is used in the grinding/preparation process for all types of fresh sausage, including turkey sausage, Italian sausage, and Bratwurst.

Hazard Analysis and Critical Control Point (HACCP) programs that are employed within the meat industry are typically aimed at managing the risk of bacterial contamination at each processing step. As mentioned earlier, carcass spraying, both pre- and post-evisceration, is a common risk-reduction practice. On the other hand, there is no treatment yet available to reduce the risk of spreading bacterial contamination throughout an entire batch during the grinding process of meat and fat to make fresh sausage or luncheon meat.

A typical HACCP program practiced in the cooked poultry industry is to locate the cooking facility at a site remote from the fresh poultry processing side. This reduces the risk of bacterial contamination being transferred from the fresh processing side, where it is rampant, to the cooked processing side. Such contamination of the cooked poultry would have very serious product safety issues since the cooked poultry is likely to be consumed without further processing to destroy bacteria. When bacterial contamination has spread from the fresh poultry side to the cooked poultry side, the contaminated meat cannot be sold, and product recall measures may have to be initiated. To alleviate against these costly situations, fresh poultry and fresh poultry pieces that are to be cooked before sale are covered with ice prior to leaving for the cooking facility in order to arrest microbiological activity on the meat and skin. However, there is presently no means available for eliminating the spoilage and pathogenic microorganisms that are present on fresh poultry pieces to reduce the risk of bacterial contamination at the cooking facility.

Several attempts have been made to delay the onset of the naturally occurring decomposition processes that occur in perishable foods that are commonly packed on ice. Most of these attempts include incorporating a biocidally active composition or additive into water used to make ice. This ice is sometimes referred to as a frozen biocidally-active composition. During storage and transportation, as the ice melts, the biocide is released to provide efficacy against spoilage and pathogenic microorganisms still remaining on the food.

In the prior art, for example, chlorine dioxide has been introduced into water used to make ice for packing fruit, vegetables, seafood, and shellfish. U.S. Pat. No. 6,814,984 discloses a frozen composition of chlorite and chloride ions designed to form chlorine dioxide in-situ. When fresh fish were placed in contact with the composition, both bacterial counts and amine odors were reduced. U.S. Pat. No. 6,328,909 also disclosed a “chlorine dioxide-containing ice” that employed a solution of a precursor mixture of a metal chlorite salt and a protic acid. The frozen composition was intended for use with meat, fish and poultry.

There are several problems, however, with using chlorine dioxide or chlorine dioxide precursors to make a frozen biocidally-active composition. The problems are so significant that such compositions are not suitable for commercial use and are not typically used. Chlorine dioxide is a noxious and volatile gas that has very limited solubility in water. One problem with making ice containing chlorine dioxide or chlorine dioxide precursors is that chlorine dioxide vapor is forced into the surrounding atmosphere, causing many operational difficulties. In particular, chlorine dioxide fumes are highly irritating to the ice machine operators, and are corrosive to metal equipment and structures. The chlorine dioxide concentration cannot be decreased, however, because the intent and effectiveness of the composition would be compromised.

Another problem with using chlorine dioxide and chlorine dioxide-forming compositions is the generation of chlorite and chlorate disinfection by-products that are of toxicological concern. Chlorate is a suspected carcinogen and is always a by-product of the acid-activated conversion of sodium chlorite into chlorine dioxide. Thus, the Food and Drug Administration (FDA) imposes strict rules on the level of chlorine dioxide that is permitted to contact food and for use in water.

Another example of a frozen biocidally-active composition is described in U.S. Pat. No. 5,950,435. This patent teaches the practice of freezing an aqueous suspension of a solid silver-impregnated zeolite to make ice for packing fresh fish. The composition reduced microbiological plate counts and helped control undesirable odors. A major limitation of this technology, however, is that as the ice melts, the solid silver-impregnated zeolite remains on the surface of the food and must be washed off before the food can be consumed, as the silver-zeolite residue is toxic to humans. Because of this problem, ice containing silver-impregnated zeolite is not commercially viable and is not typically used. In the case of the instant invention, the silver-impregnated zeolite composition could not be used, as the antimicrobial product becomes homogenous with the finished food product, and it would be impossible to wash off any residual from the food item.

Thus, there is a clear need for a composition that is effective in preventing spoilage and can be incorporated into water to make ice for use in packing perishable foods such as fresh fruit, vegetables, meat, poultry, seafood, and shellfish. There is also a need for a method to reduce the risk of bacterial contamination from spreading into an entire batch of sausage or luncheon meat when a bacterially contaminated infected carcass is chopped up and ground. As the ice melts, the composition should be released into the aqueous phase and continue to be effective in reducing spoilage and pathogenic microorganisms that remain on or in the food. The composition should be easy to use and must not cause corrosion of the icemaking machine, nor should it release noxious or corrosive vapors into the atmosphere during the icemaking process. Additionally, the composition should be safe to apply and not create or decompose into harmful by-products or residues with any toxicological concern for human safety or dietary consumption. This invention addresses all of these needs.

### SUMMARY OF THE INVENTION

This invention includes antimicrobial ice compositions (also called frozen antimicrobial compositions); methods of preparing the antimicrobial ice compositions; and methods of using the compositions.

The antimicrobial ice compositions include a frozen aqueous solution of an equilibrium mixture of at least one peroxycarboxylic acid (preferably peracetic or peroxyacetic acid (PAA)) and hydrogen peroxide (HP). The method of preparing the compositions requires the introduction of an equilibrium mixture of peroxycarboxylic acid and HP to water and chilling the solution until it freezes solid. The compositions of the invention do not corrode the ice machine heat exchanger surfaces as do chlorination chemistries, nor do they give rise to the noxious and toxic vapors that occur when chlorine dioxide solutions are frozen.

One method of using the antimicrobial ice compositions includes cubing, crushing, or shaving the frozen composition and packing it around a perishable food, such as fresh fruit, fresh vegetables, meat, poultry, fish, seafood, or shellfish, and storing or transporting the fresh food on the ice at a temperature that allows the ice to melt slowly. During storage and transportation, as the antimicrobial ice melts, the peroxycarboxylic acid and HP are gradually “time released” to the aqueous phase to provide efficacy on contact against spoilage and pathogenic microorganisms still resident on the food. The method enhances freshness and prolongs the shelf-life of fresh fruit, fresh vegetables, meat, poultry, fish, seafood, and shellfish; has no toxicologically significant or harmful by-products; and reduces the number of spoilage and pathogenic microorganisms.

Another method of using the antimicrobial ice compositions includes cubing, crushing, or shaving the frozen composition and adding it to the meat in the grinding process when making fresh sausage or luncheon meat. During subsequent processing, as the antimicrobial ice melts, the peroxycarboxylic acid and HP are released to the aqueous phase to provide efficacy against any spoilage or pathogenic microorganisms that may have spread to the sausage or luncheon meat product from the surface of a contaminated carcass. The method safeguards the fresh sausage and luncheon meat food chain and serves to prolong the useful shelf-life without the formation of toxicologically significant or harmful by-products.

### DETAILED DESCRIPTION OF THE INVENTION

### Compositions

The antimicrobial ice composition (also referred to here as PAA-HP-ice) is a frozen solution that includes a mixture of peroxycarboxylic acids and HP. A number of different peroxycarboxylic acids can be used, although PAA is preferable. The antimicrobial efficacy of the composition is most strongly influenced by the amount of peroxycarboxylic acids that it contains. The concentration of peroxycarboxylic acids is preferably about 2 to about 200 ppm, and most preferably about 10 to about 50 ppm. If the weight ratio of HP to peroxycarboxylic acids in the solution used to prepare the antimicrobial ice composition is 5:1, then the concentration of HP is preferably about 10 to about 1000 ppm, most preferably about 50 to about 250 ppm.

### Methods of Preparation

The antimicrobial ice compositions are prepared by the following methods:

An equilibrium mixture of peroxycarboxylic acid and HP is obtained. If PAA is used, suitable equilibrium mixtures may include numerous commercially available products, including Perasan and Perasan A (Enviro Tech Chemical Services); Vortexx, Matrixx, Tsunami 100 and 200 (Ecolab); Vigorox and FMC-323 (FMC); Proxitane EQ Liquid Sanitizer and Proxitane WW-12 Microbiocide (Solvay); and Peraclean 5% and 15% (Degussa), in addition to numerous other similar products on the market.

Although the primary active ingredient is preferably PAA, other peroxycarboxylic acids or mixtures thereof can be used. C₁-C₄ peroxycarboxylic acids would be the most useful, and may be used alone or in combination with C₆-C₁₈ peroxycarboxylic acids. A C₁-C₄ peroxycarboxylic acid is intended to mean the product of oxidation of a C₁-C₄ carboxylic acid or mixtures thereof (both simple or substituted C₁-C₄ carboxylic acids), whereas the carboxylic acid contains from 1-4: carbon atoms per molecule. A C₆-C₁₈ peroxycarboxylic acid is intended to mean the product of oxidation of a C₆-C₁₈ carboxylic acid (such as a fatty acid) or mixtures thereof, thus forming a peroxycarboxylic acid having from 6-18 carbon atoms per molecule.

Although it is preferable to use a PAA:HP ratio of approximately 1 part PAA (or mixture of PAA with or without other peroxycarboxylic acids) to 5 parts HP, other ratios may be used. Typically, equilibrium peroxycarboxylic acid formulations are made with ratios that are greatly variable in the amounts of acetic acid and HP associated with the amount of peroxycarboxylic acid that is also present. Equilibrium mixtures of peroxycarboxylic acid-HP can be commercially produced with PAA:HP ratios as low as 1:0.1, and as high as 1:35 (wt/wt).

The equilibrium mixture of PAA (or other peroxycarboxylic acids as described above) and HP is then mixed with water to make the final concentration of the solution preferably about 2 to about 200 ppm PAA (or other peroxycarboxylic acids as described above) and about 10 to about 1000 ppm HP, and most preferably about 10 to about 50 ppm PAA (or other peroxycarboxylic acids as described above) and about 50 to about 250 ppm HP. The equilibrium mixture of PAA (or other peroxycarboxylic acids as described above) and HP is then added to water. This can be accomplished in any common manner, including using a commercial chemical injection pump.

The solution is then frozen. To prepare very small amounts of antimicrobial ice, the solution may be frozen in ice trays or any other container in a freezer. To prepare a larger volume of antimicrobial ice, a commercial icemaking machine is preferably used (e.g. a North Star Flake Ice Maker which is available in a variety of models having a capacity for making two to 56 tons of ice per day). In this design of ice maker, the inside surface of a vertical drum is chilled, using an ammonia or non-ozone depleting refrigerant. A thin film of water is sprayed onto the surface by a rotating spray bar where it immediately flash-freezes. The ice is then scraped from the surface with a blade that rotates just behind the spay bar, where it falls into a storage chamber positioned beneath the ice maker. The bare surface that is exposed post-harvest is resprayed with more water to initiate another icemaking cycle.

In an alternative design of commercial ice maker, the ice is made on a metal freezer plate where it is allowed to build up. When the prescribed height has built up, hot refrigerant vapor is directed through the freezer plate coils to melt the layer of ice adjacent to the plate. This causes the ice mass to break free from the freezer plate and fall into a storage bin located below the ice maker.

Regardless of the machine or device used, the process of freezing the solution is preferably performed quickly, prefereably in a matter of seconds or fractions thereof. If the antimicrobial ice composition solution is not frozen quickly, the solution freezes in a disproportionate fashion, such that the water freezes first and the PAA-HP mixture freezes last, resulting in ice that is not uniform in its composition. When such non-uniform ice is used as an antimicrobial ice, as the ice melts, the resulting liquid may exhibit a sporadic or inconsistent “localized” antimicrobial effect.

If a commercial icemaking machine is not used, the solution may be frozen in a slower fashion as long as the ice is thereafter mixed well to avoid the problem of non-uniformity.

### Methods of Use

The antimicrobial ice compositions of the invention may be used cubed, crushed, or shaved, or in any other form that may be needed, depending on the type of perishible food product and storage container. The food product may be fresh fruit, fresh vegetables, meat, poultry, fish, seafood, or shellfish.

The antimicrobial ice is packed around (under and over) the food product, such that the surface of the food product is in contact with the antimicrobial ice. The food and antimicrobial ice are then stored or transported at a temperature that results in the ice slowly melting, over a period of time up to about six weeks from the time of introduction of the antimicrobial ice. As the antimicrobial ice melts, the PAA and HP are released into the aqueous phase, where they perform antimicrobial action upon spoilage and pathogenic microorganisms still remaining on the food.

The antimicrobial ice can also be used as an ingredient in the manufacture of fresh sausage (pork, Italian, Bratwurst, and turkey) and certain luncheon meats that are not cured with nitrites. The antimicrobial ice composition is added to the meat during the grinding process. In so doing, during and after the grinding, the PAA and HP are released into the meat and prevent spoilage and contamination of the entire batch if a contaminated carcass has been used in the grinding process.

### EXAMPLES

### Example 1

A 25 ppm solution of PAA (approximately 125 ppm HP) was prepared by weighing 0.43 g of a 5.81% PAA, 26.9% HP solution into a one-liter volumetric flask and making up to volume with tap water. The solution was poured into three ice trays and placed in a freezer. When the solution was completely frozen, the PAA-HP-ice cubes were placed in a sealed zippered plastic bag and crushed into coarse chunks using a mallet. Two shallow dishes were filled with a one-inch thick layer of the PAA-HP-ice chunks, and six to eight large, headless, deveined fresh shrimp were placed on top of the PAA-HP-ice in each dish. Another layer of the PAA-HP-ice chunks was placed on top of the shrimp in each dish to completely cover the shrimp. One dish was designated “B” and the other “C”. For a control, the procedure was repeated with two dishes, designated “A” and “D,” using ice made from tap water instead of the PAA-HP-ice. All four dishes were placed in a refrigerator turned to its coldest setting; By the following day, none of the ice in any of the dishes had melted, so the refrigerator was turned to a slightly warmer setting. The dishes were left for an additional 12 days.

After 12 days, the four dishes contained frozen solids, shrimp, and melted water. Ten individuals were asked if they could detect any fishy odors emanating from the shrimp dishes. The strong odor associated with rotting seafood is caused by volatile amines which result from bacterially-induced proteolysis of the flesh. In a blind test, each individual was asked to identify the dish or dishes with the strongest “fishy” odor. Table I sets forth the recorded opinions of the individuals.

TABLE I

| Number | |
|---|---|
| of people | |
| (out of 10) | Odor Rating |
| 6 | Identified A and D as having the strongest fishy odor |
| 3 | Identified D only, as having the strongest fishy odor |
| 1 | Could not tell any odor difference between any of the |
| | 4 samples |

These results show that nine out of 10 people identified dishes “A” or “D” as having the strongest fishy odor, while on person identified dishes “B” or “C.” This suggests that the shrimp in dishes B and C that were covered with the PAA-HP-ice suffered far less bacterially-induced proteolysis than the shrimp in dishes A and D that were covered with ice made from tap water. To probe this further, the melted water of each shrimp sample was serially diluted and plated onto 3M Petrifilm responsive to aerobic bacteria. After incubation for 24 hours at 37° C., the viable total aerobic bacterial colonies were enumerated. The data is set forth in Table II.

TABLE II

| Sample | Type of Ice | Log₁₀ CFU/ml |
|---|---|---|
| A | Tap water ice | 3.4 |
| B | PAA-HP-ice | 1.4 |
| C | PAA-HP-ice | 0.6 |
| D | Tap water ice | 2.3 |

The data show that the PAA-HP-ice was surprisingly effective in reducing the number of bacteria that are associated with the shrimp by about two orders of magnitude.

### Example 2

A 25 ppm solution of PAA (approximately 125 ppm HP) was prepared by weighing 0.43 g of a 5.81% PAA, 26.9% HP solution into a one-liter volumetric flask and making up to volume with tap water. The solution was poured into three ice trays and placed in a freezer. When the solution was completely frozen, the PAA-HP-ice cubes were placed in a sealed zippered plastic bag and crushed into coarse chunks using a mallet. Two shallow, perforated dishes were covered with a one-inch thick layer of the PAA-HP-ice chunks, on top of which were placed six to eight organically-grown carrots that had been bathed in a culture medium containing about 10⁷ colonies of E. Coli bacteria per ml. The carrots were then completely covered with another layer of the PAA-HP-ice chunks. The perforated dishes containing the crushed PAA-HP-ice and inoculated carrots were then placed on top of a tray designed to collect the water that melted from the ice. For the control, two identical perforated dishes were covered with a 1 inch thick layer of untreated ice made from tap water. Six to eight carrots of the same lot of subject carrots treated with E. coli similarly used in the two “treated” ice dishes were placed into the control dishes. They were then completely covered with untreated ice made with tap water. All four trays were placed in a refrigerator that was kept at 38-40° F.

After 24 hours, the water collected in the drip pans was serial diluted and plated onto 3M Petrifilm total coliform bacteria plates. After incubating the Petrifilm total coliform bacteria plates overnight at 37° C., the viable bacterial colonies were enumerated. The results are shown in Table III.

TABLE III

| | | | ppm PAA in Drip |
|---|---|---|---|
| Sample | Type of Ice | Log₁₀ CFU/ml | Pan Water |
| 1 | Tap water ice | 4.0 | — |
| 2 | Tap water ice | 4.5 | — |
| 3 | PAA-HP-ice | 0.0 | 2.1 |
| 4 | PAA-HP-ice | 0.0 | 1.8 |

These results demonstrate that there was a dramatic difference in the microbial quality of the water dripping from the carrots depending on whether the ice used to cover the carrots was PAA-HP-ice or tap water ice. Water melted from tap water ice registered E. coli plate counts four orders of magnitude higher than water melted from PAA-HP-ice. In addition, it was most interesting and unexpected to recover such a large amount of PAA in the drained solution after a 24 hour period, as PAA is known to be a strong oxidizer, and has a relatively short half-life of 3-5 hrs once diluted from its equilibrium condition.

The carrots were then stored in the refrigerator and replenished with the appropriate ice as necessary to keep them covered. After six days, the carrots were taken off the ice and a single carrot from each tray were selected for surface swabbing using protective sterile gloves to enumerate viable E. coli bacteria still remaining on the surface. This involved gently rubbing the surface of an entire carrot with the Q-tip of a 3M Quick Swab followed by vigorously shaking the swab in 1 ml. of nutrient broth to dislodge the E. coli bacteria from the Q-tip and into the aqueous medium. This solution was then serially-diluted as necessary and plated onto 3M Petrifilm total coliform bacteria plates. After incubating the Petrifilm total coliform bacteria plates overnight at 37° C., the viable colonies were enumerated. The results are shown in Table IV.

TABLE IV

| Sample | Type of Ice | Swab log₁₀ CFU/ml |
|---|---|---|
| 1 | Tap water ice | 1.6 |
| 2 | Tap water ice | 2.1 |
| 3 | PAA-HP-ice | 0.0 |
| 4 | PAA-HP-ice | 0.0 |

These data show that the carrots that had been stored in PAA-HP-ice were devoid of E. coli, bacteria on their surfaces, whereas those stored in tap water ice still retained a high level of pathogenic bacteria.

### Example 3

A culture of E. coli was prepared by removing a loop of bacteria from a stock culture growing on a refrigerated brain heart infusion (BHI) agar slant and placing in 100 ml of nutrient broth. This was incubated at 35° C. overnight. The viable cells were separated from the nutrient broth using a high speed centrifuge followed by decanting the aqueous phase. The cells were resuspended in 65 ml of sterile Butterfield buffer solution.

A piece of fresh pork meat (about 1440 g) was cut into chunks about one square inch, and placed in a bowl. The meat was manually mixed with the E. coli cells suspended in 65 ml of Butterfield buffer, and then separated into two portions of approximately equal weight.

A 250 ppm solution of PAA (approximately 83 ppm HP) was prepared by weighing 1.7123 g of a 14.6% PAA, 5% HP solution into a one-liter volumetric flask and making up to volume with reverse osmosis (RO) water. The solution was poured into an ice tray and placed in a freezer. When the solution was completely frozen, one 20 g PAA-HP-ice cube was removed, placed in a sealed zippered plastic bag and crushed into fine chunks using a mallet. The same was done for an ice cube prepared using only RO water. This crushed ice was immediately hand-mixed with one portion of the E. coli-contaminated pork meat so that there was about 3% by weight of crushed ice present. After that, the contaminated pork/ice blend was ground up to sausage meat using an electrical kitchen grinder. Upon cleaning and sanitizing the grinder, the exercise was repeated for the PAA-treated crushed ice. Eleven grams of both sets of sausage meat were placed into 99 ml of sterile Butterfield buffer solution and mixed thoroughly. Each solution was serially diluted and plated onto 3M petrifilm for total coliforms. Following incubation of the petrifilms at 35° C. overnight, the number of viable bacteria remaining was enumerated. Table V shows the results.

TABLE V

| Initial | E. coli counts | E. coli counts | % reduction |
|---|---|---|---|
| E. coli | using RO ice | using PAA-treated | using PAA |
| counts/CFU/g | water/CFU/g | ice/CFU/g | treated-ice |
| 2.9 × 10⁶ | 1.3 × 10⁶ | 6.2 × 10⁵ | 50 |

It can be seen that using PAA-HP-ice to cool the sausage meat during the grinding process results in the destruction of about half the bacteria present on the meat.

### Example 4

The water used to make ice at a Northern California grower-packer-shipper of fresh produce was treated with an equilibrium PAA-HP solution. Initially, the water feed to the commercial icemaking machines was dosed with peroxyacetic acid using Perasan A™, an equilibrium solution containing 5.6% PAA and 26.5% HP in water. Using a flow proportional controller and a diaphragm pump, the solution was injected to a level of 25 ppm PAA just prior to the water prechillers. The treated water was then diverted to a commercial “North Star” icemaking machine, and was flash-frozen on the ammonia cooled heat exchange surfaces of the ice machine. Then a rotating blade was used to shave the PAA-HP-ice off the surface in small chunks. The shaved PAA-HP-ice was stored in a cold storage room from where it was augered to the ice injection pit, where it was mixed with fresh make-up water. The PAA-HP-ice-water slush was then pumped into stacks of boxed fruit and vegetables where the PAA-HP-ice remained on the produce as the water drained back into the pit. As the PAA-HP-ice in the pit partially melted when contacting the make-up water, it is believed that a sanitary dose of PAA would be released into the pit water to provide additional benefits to the area prone to contamination with dirt, debris and microorganisms washed from the produce during ice injection.

Table VI shows the typical PAA distribution at several points in the icemaking and injection circuit.

TABLE VI

| Location | PAA/ppm |
|---|---|
| Water feed to the ice machine | 25 |
| Water melted from freshly made ice | 20-25 |
| Water in the ice pit injection water | 2-15 |

The data indicate that the dose injected into the ice machine feed water was extremely consistent. PAA recovered from the PAA-HP-ice was occasionally slightly lower, but the amount in the ice pit injection water varied considerably. The low amounts recovered from the ice-slush pit was attributed to the variable soil, organic and bacterial load that was washed into the pit water from the produce. Additionally, it was discovered that untreated plant water was manually added to the ice-slush pit due to low levels caused by loss of water during the ice packing process. Consequently, it was decided to inject PAA directly into the ice pit make-up water instead of relying solely on PAA released from melted PAA-HP-ice.

This icemaking processing plant used water from a nearby irrigation canal that contained considerable amounts of coliform bacteria. The presence of coliform bacteria in a water system indicates the presence of disease-causing microorganisms. Strict sanitation standards at the facility mandated that water contacting the produce during ice injection must contain zero detectable coliform bacteria. To accomplish this goal, it was decided to dose the ice-slush pit make-up water with 25 ppm of PAA sanitizer. A second diaphragm pump was connected to inject the PAA-HP solution using a solenoid valve that was activated when the flow of make-up water to the ice pit was turned on.

Now that both the water to the icemaking machines and the make-up water to the ice injection pit were being treated with 25 ppm PAA, a consistently high level of PAA was always present at all places in the icemaking circuit. Unsurprisingly, excellent microbiological control was secured throughout the entire produce packing operation. No coliform bacteria have been detected in water draining from the produce and back into the ice injection pit since the PAA-HP treatment system was installed, for many months.

In addition to achieving an outstanding sanitation program, it was found that the processing plant was able to make PAA-HP-ice from water treated with PAA-HP without corrosion-damage to the heat exchange surfaces. Further, no noxious or toxic odors were detected by plant personnel during the production, storage, and use of the PAA-HP-ice in this commercial operation.

The invention has been described above with reference to the preferred embodiments. Those skilled in the art may envision other embodiments and variations of the invention that fall within the scope of the claims.

We claim:

1. A frozen antimicrobial composition, including an equilibrium mixture of at least one peroxycarboxylic acid and hydrogen peroxide in water.

2. The frozen antimicrobial composition of claim 1, wherein the peroxycarboxylic acid is peracetic acid.

3. The frozen antimicrobial composition of claim 1, wherein said equilibrium mixture contains about 2 to about 200 ppm peroxycarboxylic acid and about 10 to about 1000 ppm HP.

4. A method of preparing a frozen antimicrobial composition, comprising:
a. preparing an equilibrium mixture of at least one peroxycarboxylic acid and hydrogen peroxide in water; and
b. freezing said equilibrium mixture.

5. The method of claim 4, wherein the peroxycarboxylic acid is peracetic acid.

6. The method of claim 4, wherein said equilibrium mixture contains about 2 to about 200 ppm peroxycarboxylic acid and about 10 to about 1000 ppm hydrogen peroxide.

7. The method of claim 4, wherein said freezing step is performed using an icemaking machine.

8. A method of reducing microbial contamination and spoilage of a perishable food product, comprising:
a. Packing a frozen antimicrobial composition around a food product, such that the surface of the food product is in contact with the frozen antimicrobial composition, wherein said frozen composition includes an equilibrium mixture of at least one peroxycarboxylic acid and hydrogen peroxide; and
b. storing said perishable food product in said frozen antimicrobial composition at a temperature that allows said frozen antimicrobial composition to melt.

9. The method of claim 8, wherein said food product is selected from the group consisting of fresh fruit, fresh vegetables, meat, poultry, fish, seafood, and shellfish.

10. The method of claim 8, wherein said equilibrium mixture contains about 2 to about 200 ppm peroxycarboxylic acid and about 10 to about 1000 ppm hydrogen peroxide.

11. A method of reducing microbial contamination and spoilage of meat during the making of sausage or luncheon meat, comprising:
a. adding a frozen antimicrobial composition to meat during the grinding of the meat, wherein said frozen antimicrobial composition includes an equilibrium mixture of at least one peroxycarboxylic acid and hydrogen peroxide; and
b. allowing said frozen antimicrobial composition to melt during and after said grinding of the meat.
